(19) United States
(12) Patent Application Publication
(10) Pub. No.: US 2023/0394210 A1
(43) Pub. Date: Dec. 7, 2023

(54) Semiconductor Device Simulation Platform

(71) Applicant: Taiwan Semiconductor Manufacturing Company, Ltd., Hsin-Chu (TW)

(72) Inventors: Nuo Xu, San Jose, CA (US); Zhengping Jiang, Hsinchu (TW); Zhiqiang Wu, Hsinchu County (TW)

(21) Appl. No.: 17/833,439

(22) Filed: Jun. 6, 2022

(51) Int. Cl. G06F 30/331; G06F 30/337

(52) U.S. Cl. CPC G06F 30/331; G06F 30/337; G06F 2115/02

(57) ABSTRACT

An exemplary method for semiconductor device simulation includes receiving a device structure, generating a mesh for the device structure, simulating electrical behavior of the device structure using the mesh, and adaptively adjusting the mesh during the simulating. The adaptively adjusting the mesh includes performing a multi-level restriction-prolongation (MLRP) process that decreases and increases a resolution of the mesh. The semiconductor device simulation can be performed by a semiconductor simulation system that includes a central processing unit, a memory, and a hardware accelerator. The MLRP process is at least partially parallelized on the hardware accelerator, such as a GPU.

### BACKGROUND

The semiconductor integrated circuit (IC) industry has experienced rapid growth. Technological advances in IC materials and design have produced generations of ICs where each generation has smaller and more complex than previous generations. For example, in the course of IC evolution, functional density (i.e., the number of interconnected devices per chip area) has generally increased while feature size (i.e., the smallest component (or line) that can be created using a fabrication process) has decreased. Such scaling down has also increased the complexity of processing and manufacturing of ICs and, for these advancements to be realized, similar developments in IC processing and manufacturing are needed.

For example, fast and accurate understanding of electrical behavior of semiconductor devices is important for IC designers to optimize semiconductor design and/or fabrication thereof. To speedup time-to-market (TTM) for semiconductor devices, many research efforts are directed to developing an electronic design automation (EDA) platform that can provide accurate and fast semiconductor device simulations. Conventional EDA platforms for semiconductor device simulations are computationally inefficient. For example, existing semiconductor device simulation platforms rely on CPU-only computing systems and necessitate high resolution mesh grids (e.g., fine mesh grids having mesh elements less than about 1 nm), thereby providing extremely time consuming and memory consuming for large-scale semiconductor device simulations. Therefore, while existing EDA platforms have generally been adequate for their intended purposes, they have not been entirely satisfactory in every aspect.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a simplified block diagram of a semiconductor device simulation system, in portion or entirety, according to various aspects of the present disclosure.

FIG. 2 is a fragmentary cross-sectional view of a multichip package, in portion or entirety, that can provide a hardware platform for a semiconductor device simulation system, such as depicted in FIG. 1, according to various aspects of the present disclosure.

FIG. 3 is a semiconductor device simulation method, in portion or entirety, that implements multi-level restriction-prolongation (MLRP) algorithms for adaptively adjusting meshes according to various aspects of the present disclosure.

FIG. 4 illustrates execution of an MLRP algorithm, in portion or entirety, on a mesh according to various aspects of the present disclosure.

FIG. 5A illustrates a mesh that undergoes an MLRP-restriction of the MLRP algorithm, in portion or entirety, according to various aspects of the present disclosure.

FIG. 5B illustrates a matrix that undergoes an MLRP-restriction of the MLRP algorithm, in portion or entirety, according to various aspects of the present disclosure.

FIGS. 6A-6D illustrate various restriction-prolongation cycle patterns, in portion or entirety, according to various aspects of the present disclosure.

### DETAILED DESCRIPTION

The present disclosure relates generally to semiconductor devices, and more particularly, to simulating and/or modeling of semiconductor devices.

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are formed in direct contact, and may also include embodiments in which additional features may be formed interposing the features, such that the features may not be in direct contact. In addition, spatially relative terms, for example, “lower,” “upper,” “horizontal,” “vertical,” “above,” “over,” “below,” “beneath,” “up,” “down,” “top,” “bottom,” etc. as well as derivatives thereof (e.g., “horizontally,” “downwardly,” “upwardly,” etc.) are used for ease of the present disclosure of one features relationship to another feature. The spatially relative terms are intended to cover different orientations of the device including the features.

Electronic design automation (EDA) collectively refers to hardware and software, along with processes and services associated therewith, used to design, model, simulate, test, and analyze integrated circuits (ICs) and semiconductor devices thereof. As IC technology nodes continue to scale, EDA has become integral to efficiently, accurately, and cost-effectively optimizing IC designs and fabrication thereof. Technology computer-aided design (TCAD) is a branch of EDA that simulates and models fabrication and operation of semiconductor devices and ICs semiconductor fabrication, semiconductor devices (and their corresponding electrical characteristics), and ICs. For example, TCAD process simulation involves simulating a semiconductor manufacturing process flow (e.g., etching, deposition, diffusion, implantation, etc.) to generate a simulated semiconductor device, TCAD device simulation involves simulating electrical characteristics of a semiconductor device (which may be provided by TCAD process simulation), and TCAD circuit simulations can involve simulating behavior of an IC circuit containing multiple semiconductor devices and interconnections (which may be provided by TCAD device simulation). The present disclosure is generally related to a feasible TCAD solution, and more particularly, to a TCAD-based device simulation platform for providing a fast and accurate EDA environment and high-performance computing (HPC) solution for semiconductor device simulations. Embodiments of the present disclosure can substantially speedup continuum-scale, physics-based semiconductor device simulations and/or models without sacrificing accuracy by implementing adaptive meshing, as described herein, and parallelizing a portion of the semiconductor device simulations on hardware accelerators.

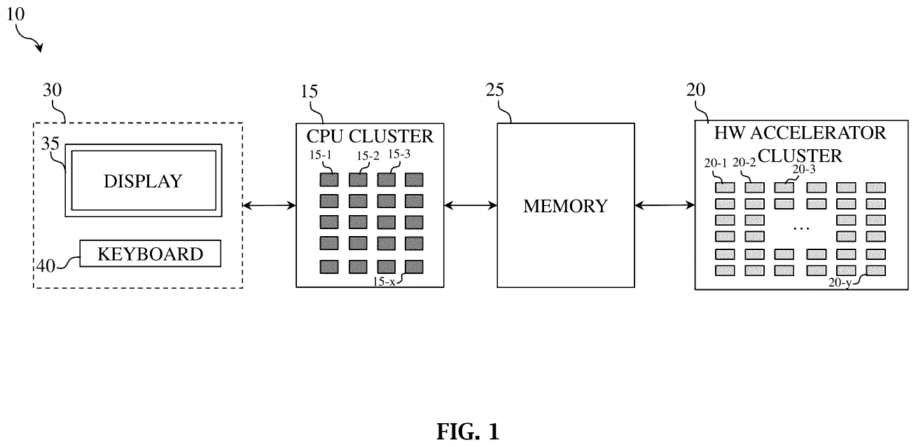

FIG. 1 is a simplified block diagram of a technology computer-aided design (TCAD) semiconductor device simulation system 10, in portion or entirety, according to various aspects of the present disclosure. Semiconductor device simulation system 10 is a hardware-based system that simulates behavior and/or characteristics of semiconductor devices, such as electrical behavior and/or characteristics, thermal behavior and/or characteristics, optical behavior and/or characteristics, other behavior and/or characteristics, or combinations thereof. FIG. 1 has been simplified for the sake of clarity to better understand the inventive concepts of the present disclosure. Additional features can be added in semiconductor device simulation system 10, and some of the features described below can be replaced, modified, or eliminated in other embodiments of semiconductor device simulation system 10.

Semiconductor device simulation system 10 includes a central processing unit (CPU) cluster 15, a hardware (HW) accelerator cluster 20, a memory 25, input/output (I/O) components (for example, a display 35 and a keyboard 40), and other components (collectively referred to as “the components” hereafter) that facilitate semiconductor device simulation tasks as described herein. The components are communicatively connected by a bus, a switching fabric, other communication mechanism, or combinations thereof. Communication mechanism(s) of semiconductor device simulation system 10 facilitates transfer and/or communication of data, instructions, signals, other information, or combinations thereof between the components. In some embodiments, the communication mechanism(s) support an InfiniBand® (IB) network among and/or within semiconductor device simulation system 10 and/or the components, and semiconductor device simulation system 10 and/or the components can communicate using IB networking communication protocols. The IB network can facilitate high-speed communications for high-performance computing (HPC) applications. The communication mechanism(s) can support other networks and/or communication protocols (e.g., Ethernet, WiFi, etc.) among and/or within semiconductor device simulation system 10 and/or the components.

CPU cluster 15 includes a cluster of CPUs, such as a CPU 15-1, a CPU 15-2, a CPU and so on, to a CPU 15-x, where x is an integer and represents a total number of CPUs of the CPU cluster. CPU cluster 15 is connected to memory 25 and is configured to execute a series of computer-readable instructions (which may be stored in memory 25) to perform some or all of the semiconductor device simulation operations described herein. In some embodiments, CPU cluster 15 may be a single CPU chip that includes multiple processing cores (represented by CPU 15-1 to CPU 15-x). In some embodiments, CPU cluster 15 may be a cluster of separate CPU chips (represented by CPU 15-1 to CPU 15-x), each of which includes one or more processor cores. In some embodiments, CPU 15-1 to CPU 15-x can include local memory and/or access a shared memory of CPU cluster 15.

Semiconductor device simulation system 10 is configured to completely or partially parallelize semiconductor device simulation on HW accelerator cluster 20. In other words, semiconductor device simulation system 10 offloads a portion of semiconductor device simulation to HW accelerator cluster 20. HW accelerator cluster 20 is connected to memory 25 and is configured to execute a series of computer-readable instructions (which may be stored in memory 25) to perform some or all of the semiconductor device simulation operations described herein. HW accelerator cluster 20 includes a HW accelerator 20-1, a HW accelerator 20-2, a HW accelerator 20-3, and so on to a HW accelerator 20-y, where y is an integer and represents a total number of HW accelerators of HW accelerator cluster 20. In some embodiments, HW accelerator cluster 20 may be a single HW accelerator chip that includes multiple processing cores (represented by HW accelerator 20-1 to HW accelerator 20-x). In some embodiments, HW accelerator cluster 20 may be a cluster of separate HW accelerator chips (represented by HW accelerator 20-1 to HW accelerator 20-x), each of which includes one or more processor cores. HW accelerators are generally specialized hardware components, other than CPUs, within a computing system configured to offload certain computing tasks and/or processes, enabling greater efficiency than is possible in software running on a general-purpose CPU alone. HW accelerators 20-1 to 20-y can include general-purpose computing on graphics processing units (GPGPUs), GPUs, field programmable gate arrays (FPGAs), application-specific integrated circuits (ASICs), digital signal processors (DSPs), tensor processing units (TPUs), artificial intelligence (AI) accelerators, machine-learning processing units (MLPUs) (e.g., processors for processing inference workloads and/or machine learning workloads, such as a deep learning accelerators), programmable logic devices (PLDs), data processing units (DPUs), physics processing units (PPUs), other hardware accelerators, or combinations thereof. In some embodiments, HW accelerators 20a-20y include a cluster of GPUs that complement CPU cluster (i.e., reduce processing load thereof) in semiconductor device simulation system 10. HW accelerators 20-1 to 20-y, such as GPUs, may include a combination of low precision/accuracy and high precision/accuracy arithmetic logic units (ALUs), such as 8-bit ALUs, 16-bit ALUs, 32-bit ALUs, 64-bit ALUs, or combinations thereof, to maximize computing power of HW accelerators 20-1 to 20-y. In some embodiments, HW accelerators 20-1 to 20-y can include local memory and/or access a shared memory of HW accelerator cluster 20.

As noted, CPU cluster 15 and HW accelerator cluster 20 are connected to memory 25. Memory locations in memory 25 can be accessed by the CPU cluster 15 (such as by processing cores thereof) and HW accelerator cluster 20 (such as by processing cores thereof). CPU cluster 15 and HW accelerator cluster 20 can access, manipulate, and store data in memory 25, such as that associated with semiconductor device simulation. CPU cluster 15 can dispatch instructions to HW accelerator cluster 20 via memory 25. Memory 25 can store operating system(s), simulation device tool(s), and data. Data can include input required for semiconductor device simulation and/or output generated by semiconductor device simulation. Semiconductor device simulation system 10 may automatically (or with user help) perform one or more operations that are implicitly or explicitly described in this disclosure. Specifically, semiconductor device simulation system 10 can load a device simulation tool into memory and use the device simulation tool to perform semiconductor device simulations as described herein (including adaptive meshing such as described herein). Semiconductor device simulation system 10 can also use the simulation tool (or another tool that is stored in memory 25) to determine whether or not to fabricate a semiconductor device based on the semiconductor device simulations (e.g., a semiconductor device may be fabricated based on a design layout of a device structure, when the semiconductor device simulations indicate that a virtual semiconductor device that corresponds with the device structure will exhibit desired features and performance characteristics.

Hardware implementations of semiconductor device simulation system 10 can be provided using IC packaging techniques that support HPC and facilitate extreme high speed data transfer between CPUs (e.g., CPU cluster 15), HW accelerators (e.g., HW accelerator cluster 20), and memory (e.g., memory 25). For example, a hardware implementation of semiconductor device simulation system 10 is provided by a chipset arranged and packaged according to a suitable multichip packaging technology, such as into a chip-on-wafer-on-substrate (CoWoS) package, an integrated-fan-out (InFO) package, a system on integrated chip (SoIC) package, other three-dimensional integrated circuit (3D IC) package, other 2.5D package, or a hybrid package implementing a combination of multichip packaging technologies. Each chip includes at least one functional IC, such as an IC configured to perform a logic function, a memory function, a digital function, an analog function, a mixed signal function, a radio frequency (RF) function, an I/O function, a communications function (e.g., provides support for wired communications and/or wireless communications by implementing desired communication protocols, such as 5G (i.e., 5th generation) wireless communications protocols, Ethernet communications protocols, IB communications protocols, etc.), a power management function, other function, or combinations thereof. In some embodiments, a chip of the chipset is a system-on-chip (SoC), which generally refers to a single chip or monolithic die having multiple functions. For example, the SoC is a single chip having an entire system, such as a computer system, fabricated thereon. The SoC may have circuitry and/or circuits for a system having a CPU, a GPU, a memory, a communications unit, and a power management unit. In some embodiments, an HPC chipset for semiconductor device simulation system 10 includes a CPU chip, a HW accelerator chip (e.g., a GPU chip, a GPGPU chip, a FPGA chip, a DSP chip, a TPU chip, an AI chip, other suitable HW accelerator chip, or combinations thereof), a memory chip (e.g., a high bandwidth memory (HBM) chip, a graphics double-data rate (GDDR) memory chip, other suitable memory chip, or combinations thereof), an I/O chip, a communications chip, power management chip, and other chips for facilitating the semiconductor device simulations as described herein. In some embodiments, at least one chip of the HPC chipset is an SoC. In some embodiments, the HPC chipset is configured to support IB networking.

Circuitry of the chips can include various passive microelectronic devices and active microelectronic devices, such as resistors, capacitors, inductors, diodes, p-type field effect transistors (PFETs), n-type FETs (NFETs), metal-oxide semiconductor (MOS) FETs (MOSFETs), complementary MOS (CMOS) transistors, bipolar junction transistors (BJTs), laterally diffused MOS (LDMOS) transistors, high voltage transistors, high frequency transistors, other suitable devices, or combinations thereof. The various microelectronic devices are configured and arranged to provide functionally distinct regions of each chip, such as control units, local memories, and ALUs of a CPU chip and/or a GPU chip. In some embodiments, one or more of the transistors are planar transistors, where a channel of a planar transistor is formed in a semiconductor substrate between respective source/drains and a respective metal gate is disposed on the channel (e.g., on a portion of the semiconductor substrate in which the channel is formed). In some embodiments, one or more of the transistors are non-planar transistors having channels formed in semiconductor fins that extend from a semiconductor substrate and extending between respective source/drains on/in the semiconductor fin, where metal gates are disposed on and wrap the channels of the semiconductor fins (i.e., the non-planar transistor is a fin-like FET (FinFET)). In some embodiments, one or more of the transistors are non-planar transistors having channels formed in semiconductor layers suspended over a semiconductor substrate and extending between respective source/drains, where metal gates are disposed on and surround the channels (i.e., the non-planar transistors are gate-all-around (GAA) transistors). In some embodiments, device components and/or device features can include a semiconductor substrate, doped wells (e.g., n-wells and/or p-wells), isolation features (e.g., shallow trench isolation (STI) structures and/or other suitable isolation structures), metal gates (for example, a metal gate having a gate electrode over a gate dielectric), gate spacers along sidewalls of the metal gates, source/drain features (e.g., epitaxial source/drain features, lightly doped source/drain regions, heavily doped source/drain regions, etc.), and a multilayer interconnect (MLI).

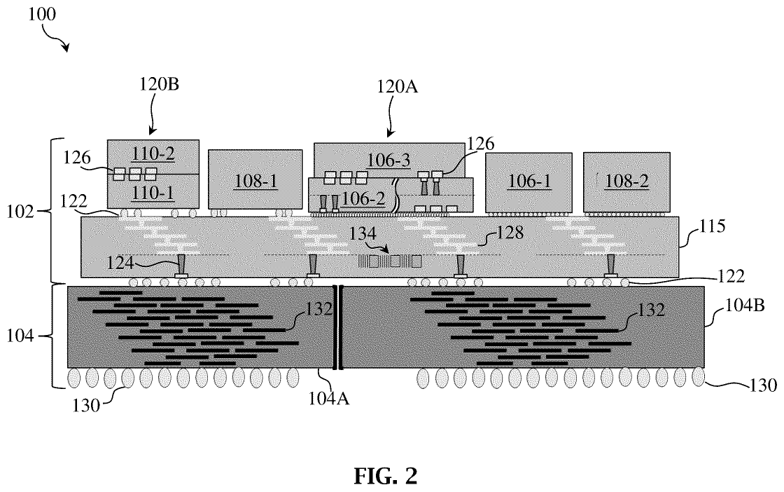

FIG. 2 is a fragmentary cross-sectional view of a multichip package 100, in portion or entirety, that is provided by arranging a chipset using a combination of multichip packaging technologies, such as CoWoS packaging technology and SoIC multi-chip packaging technology, according to various aspects of the present disclosure. Multichip package 100, which can be referred to as a 3D IC package and/or a 3D IC module, includes a CoW structure 102 attached to a substrate 104 (e.g., a package substrate), which includes a package component 104A and a package component 104B in the depicted embodiment. CoW structure 102 includes a chipset (e.g., a core chip 106-1, a core chip 106-2, a core chip 106-3, a memory chip 108-1, a memory chip 108-2, an I/O chip 110-1, and an I/O chip 110-2 electrically connected to each other) attached to an interposer 115. The chipset is arranged into at least one chip stack, such as a chip stack 120A and a chip stack 120B. Chip stack 120A includes core chip 106-2 and core chip 106-3, and chip stack 120B includes I/O chip 110-1 and I/O chip 110-2. In the depicted embodiment, chips of chip stack 120A and chip stack 120B are directly bonded face-to-face and/or face-to-back to provide SoIC packages of multichip package 100. In some embodiments, a chip stack of multichip package 100 includes a combination of chip types, such as a core chip having one or more memory chips disposed thereover. FIG. 2 has been simplified for the sake of clarity to better understand the inventive concepts of the present disclosure. Additional features can be added in multichip package 100, and some of the features described below can be replaced, modified, or eliminated in other embodiments of multichip package 100.

Core chip 106-1, core chip 106-2, and core chip 106-3 are CPU chips and/or HW accelerator chips. In some embodiments, core chip 106-1 is a CPU chip that forms at least a portion of CPU cluster 15, and core chip 106-2 and core chip 106-3 are GPU chips that form at least a portion of HW accelerator cluster 20. In some embodiments, core chip 106-1, core chip 106-2, core chip 106-3, or combinations thereof represent a stack of CPU dies, which can be bonded and/or encapsulated in a manner that provides a CPU package and/or a CPU-based SoIC package. In some embodiments, core chip 106-1, core chip 106-2, core chip 106-3, or combinations thereof represent a stack of HW accelerator dies, which can be bonded and/or encapsulated in a manner that provides a HW accelerator package (e.g., a GPU package) and/or a HW accelerator-based SoIC package (e.g., a GPU-based SoIC package). In some embodiments, core chip 106-1, core chip 106-2, core chip 106-3, or combinations thereof represent a stack of CPU dies and HW accelerator dies, which can be bonded and/or encapsulated in a manner that provides a core package and/or a core-based SoIC package. In some embodiments, core chip 106-1, core chip 106-2, core chip 106-3, or combinations thereof are SoCs.

Memory chip 108-1 and memory chip 108-2 are HBM chips, GDDR memory chips, dynamic random-access memory (DRAM) chips, static random-access memory (SRAM) chips, magneto-resistive random-access memory (MRAM) chips, resistive random-access memory (RRAM) chips, other suitable memory chips, or combinations thereof. In some embodiments, memory chip 108-1 and memory chip 108-2 are HBM chips that form at least a portion of memory 25. In some embodiments, memory chip 108-1 and memory chip 108-2 are GDDR memory chips that form at least a portion of memory 25. In some embodiments, memory chip 108-1 is an HBM chip and memory chip 108-2 is a GDDR memory chip, or vice versa, that form at least a portion of memory 25. In some embodiments, memory chip 108-1 and/or memory chip 108-2 represent a stack of memory dies, which can be bonded and/or encapsulated in a manner that provides a memory package and/or a memory-based SoIC package. The memory package may be an HBM package (also referred to as an HBM cube) or a GDDR memory package.

Core chip 106-1, core chip 106-2 (and thus chip stack 120A), memory chip 108-1, memory chip 108-2, and I/O chip 110-1 (and thus chip stack 120B) are attached and/or interconnected to interposer 115. Interposer 115 is attached and/or interconnected to substrate 104. Various bonding mechanisms can be implemented in multichip package 100, such as electrically conductive bumps 122 (e.g., metal bumps), through semiconductor vias (TSVs) 124, bonding pads 126, or combinations thereof. For example, electrically conductive bumps 122 physically and/or electrically connect core chip 106-1, core chip 106-2 (and thus chip stack 120A), memory chip 108-1, memory chip 108-2, and I/O chip 110-1 (and thus chip stack 120B) to interposer 115. Electrically conductive bumps 122 and TSVs 124 physically and/or electrically connect interposer 115 to substrate 104. TSVs 124 of interposer 115 are electrically connected to electrically conductive bumps 122 of chips and/or chip stacks of CoW structure 102 through electrically conductive routing structures (paths) 128 of interposer 115. Bonding pads 126 physically and/or electrically connect core chip 106-2 and core chip 106-3 of chip stack 120A and I/O chip 110-1 and I/O chip 110-2 of chip stack 120B. Also, dielectric bonding layers adjacent to bonding pads 126 can physically and/or electrically connect core chip 106-2 and core chip 106-3 of chip stack 120A and/or I/O chip 110-1 and I/O chip 110-2 of chip stack 120B. In some embodiments, electrically conductive bumps 122 that connect chips and/or chip stacks to interposer 115 may be microbumps, while electrically conductive bumps 122 that connect interposer 115 to substrate 104 may be controlled collapse chip connections (referred to as C4 bonds) (e.g., solder bumps and/or solder balls).

In some embodiments, substrate 104 is a package substrate, such as coreless substrate or a substrate with a core, that may be physically and/or electrically connected to another component by electrical connectors 130. Electrical connectors 130 are electrically connected to electrically conductive bumps 122 of interposer 115 through electrically conductive routing structures (paths) 132 of substrate 104. In some embodiments, package component 104A and package component 104B are portions of a single package substrate. In some embodiments, package component 104A and package component 104B are separate package substrates arranged side-by-side. In some embodiments, substrate 104 is an interposer. In some embodiments, substrate 104 is a printed circuit board (PCB).

In some embodiments, interposer 115 is a wafer, such as a silicon wafer (which may generally be referred to as a silicon interposer). In some embodiments, interposer 115 is laminate substrate, a cored package substrate, a coreless package substrate, or the like. In some embodiments, interposer 115 can include an organic dielectric material, such as a polymer, which may include polyimide, polybenzoxazole (PBO), benzocyclobutene (BCB), other suitable polymer-based material, or combinations thereof. In some embodiments, redistribution lines (layers) (RDLs) can be formed in interposer 115, such as within the organic dielectric material(s) of interposer 115. RDLs may form a portion of electrically conductive routing structures 128 of interposer 115. In some embodiments, RDLs electrically connect bond pads on one side of interposer 115 (e.g., top side of interposer 115 having chipset attached thereto) to bond pads on another side of interposer 115 (e.g., bottom side of interposer 115 attached to substrate 104). In some embodiments, RDLs electrically connect bond pads on the top side of interposer 115, which may electrically connect chips of the chipset. In some embodiments, one or more devices may be embedded in interposer 115, such as a deep trench capacitor 134.

In some embodiments, multichip package 100 can be configured as a 2.5D IC package and/or a 2.5D IC module by rearranging the chipset, such that each chip is bonded and/or attached to interposer 115. In other words, the 2.5D IC module does not include a chip stack, such as chip stack 120A and chip stack 120B, and chips of the chipset are arranged in a single plane. In such embodiments, core chip 106-3 and I/O chip 110-2 are electrically and/or physically connected to interposer by electrically conductive bumps 122.

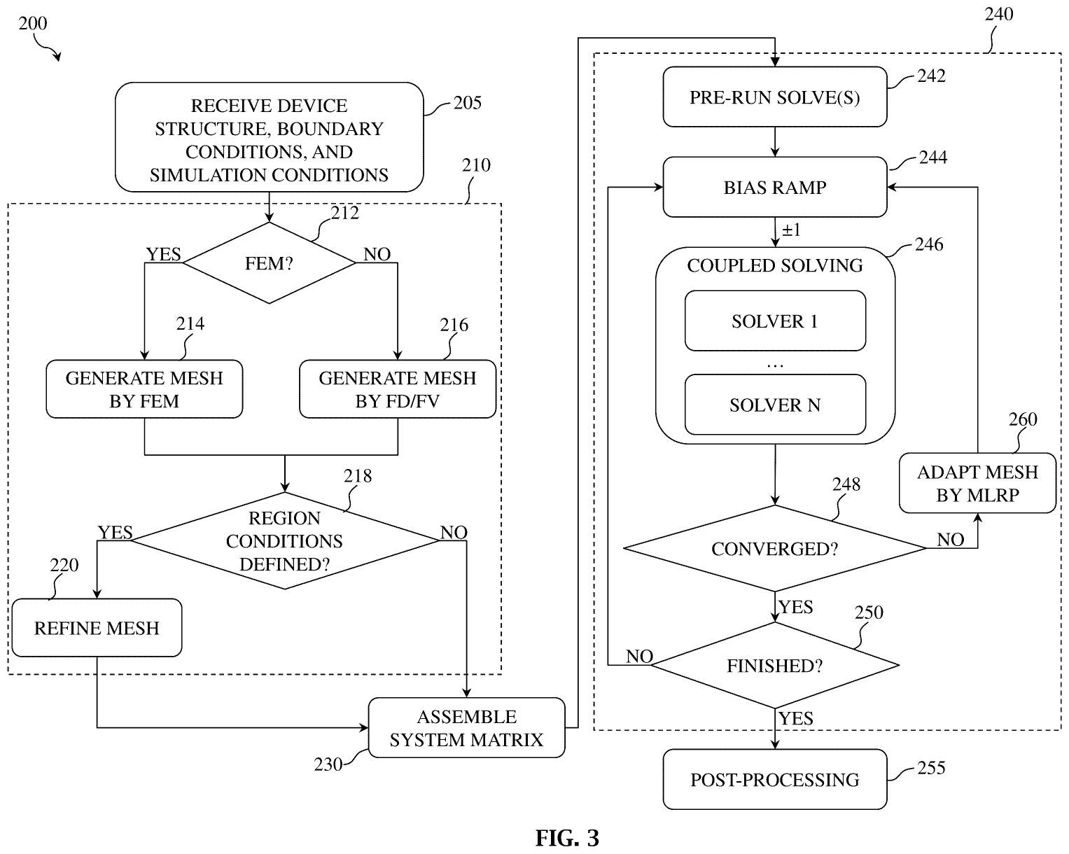

FIG. 3 is a semiconductor device simulation method 200, in portion or entirety, that implements multi-level restriction-prolongation (MLRP) algorithms according to various aspects of the present disclosure. Semiconductor device simulation method 200 simulates and/or predicts behavior and/or characteristics of semiconductor devices by solving continuum PDEs. In some embodiments, semiconductor device simulation method 200 numerically simulates electrical behavior of a transistor based on a set of PDEs. Implementing the MLRP algorithms described herein balance computational speed and accuracy to optimize simulation run time. FIG. 3 has been simplified for the sake of clarity to better understand the inventive concepts of the present disclosure. Additional features can be added in semiconductor device simulation method 200, and some of the features described below can be replaced, modified, or eliminated in other embodiments of semiconductor device simulation method 200.

At operation 205, semiconductor device simulation method 200 includes receiving a device structure that is suitable for device simulation, along with boundary conditions and simulation conditions for the device structure and its device simulation. The device structure is a representation and/or approximation of a real semiconductor device, such as a transistor. The device structure may be referred to as a virtual device. The device structure can be a one-dimensional (1D) structure, a two-dimensional (2D) structure, or a three-dimensional (3D) structure. The device structure, the boundary conditions, the simulation conditions, other conditions, or combinations thereof may be expressed in Visualization Toolkit (VTK) file format, TDR file format, DF-ISE file format, other suitable format, or combinations thereof. In some embodiments, the device structure is generated by process simulation and may be referred to as a process simulated device structure. In some embodiments, the device structure is generated by process emulation and may be referred to as a process emulated device structure. In some embodiments, the device structure is generated by a device editor (i.e., a user-drawn device structure vs. a computer-simulated device structure).

The device structure may be described by its geometry (e.g., dimensions), materials, boundaries/interfaces, locations of contacts, doping configurations and/or profiles, other suitable characteristics and/or descriptors, or combinations thereof. For a transistor, the device structure can specify and/or define a semiconductor channel (e.g., a silicon channel), a gate dielectric (e.g., a gate oxide), a gate electrode (e.g., a polysilicon gate or a metal gate), a bulk semiconductor substrate (e.g., a silicon substrate), and source/drain contacts (e.g., metal contacts). The device structure can further specify electrodes to be used in the device simulation, along with respective boundary conditions and simulation conditions. For example, the boundary conditions and/or the simulation conditions may specify and/or define a sequence of solutions to be obtained during the device simulation. For the transistor, the boundary conditions and/or the simulation conditions may specify initial biases (i.e., voltages) applied to a drain, a source, and a substrate, a bias range for application to a gate, and a step size (e.g., 0.1 V steps when the bias range is 0 V to 2 V). The boundary conditions and/or the simulation conditions may specify that one or more of the biases is fixed. In some embodiments, the boundary conditions and/or the simulation conductions may specify and/or define physical models for semiconductor devices to apply in the device simulation, such as drift-diffusion models, thermodynamic models, hydrodynamic models, other suitable models, or combinations thereof. In some embodiments, the simulation conductions may specify and/or define PDEs to be solved by the device simulation with appropriate boundary conditions, such as Poisson's equation, continuity equations for electrons, continuity equations for holes, other suitable device equations, etc.

At operation 210, semiconductor device simulation method 200 proceeds with generating a mesh for the device structure. That is, the device structure is discretized into a mesh (also referred to as a grid or a mesh grid) by a suitable mesh generation method. At operation 212, semiconductor device simulation method 200 determines whether to discretize device structure using a finite-element method (FEM) or other suitable mesh generation method. If yes, semiconductor device simulation method 200 proceeds to operation 214 to generate the mesh using FEM. If no, semiconductor device simulation method 200 continues to operation 216 to generate the mesh using a finite-difference method (FDM), a finite-volume method (FVM), other suitable mesh generation method, or combinations thereof.

The mesh generation method divides the device structure into smaller, discrete elements (also referred to as shapes or units) and a collection of the smaller, finite-sized elements form the mesh. The elements can be 2D, such as triangles and/or quadrilaterals, or 3D, such as tetrahedrons and/or hexahedrons, and the elements may be formed by and/or include vertices, edges, nodes, or combinations thereof of the mesh. In some embodiments, the mesh generation method performs Delaunay triangulation on the device structure, such that the elements of the mesh are 2D or 3D Delaunay triangles. A position and/or location of each element within the mesh corresponds with a position and/or a location of a respective portion of the device structure. Each element in the mesh has structural and/or device information that corresponds with the respective portion of the device structure, such as characteristics thereof (e.g., boundaries, interfaces, material types, dimensions, doping profiles, etc.). A number, shape, and size of the elements, vertices, edges, nodes, or combinations thereof (which can generally refer to a resolution of the mesh for device simulation) may be varied depending on type of device simulation and/or degree of accuracy needed for the device simulation.

The mesh can be a structured mesh, an unstructured mesh, or a hybrid mesh. A structured mesh exhibits regular connectivity, such as where each node is connected to a same number of elements and/or the elements have the same shapes. Structured meshes can be applied over an analytical coordinate system (e.g., a rectangular, elliptical, or spherical coordinate system), which facilitates easy mapping and identification of elements of the mesh. An unstructured mesh exhibits irregular connectivity, such as where nodes are connected to different numbers of elements and/or the elements have different shapes. Unstructured meshes may better represent the device structure but my need more complex mapping structures for the elements of the mesh, such as an adjacency matrix (or list) and/or a node coordinate list.

At operation 218, semiconductor device simulation method 200 determines whether any region conditions have been defined for the mesh. If yes, semiconductor device simulation method 200 proceeds to operation 220 to refine the mesh according to the region conditions before proceeding to operation 230. For example, finer resolutions may be desired at regions of the mesh that correspond with interfaces of the device structure (e.g., an oxide/semiconductor interface that corresponds with an interface between a gate dielectric and a channel), portions of the device structure having doping gradients, portions of the device structure that exhibit higher current density (e.g., a channel), portions of the device structure that exhibit higher electric fields (e.g., a channel, a drain, a depletion region, etc.), portions of the device structure that exhibit higher charge generation, portions of the device structure that are of particular interest based on the particular device simulation, design requirements, other considerations, etc. Region conditions can thus define and/or specify regions of the device structure and/or the mesh that need different meshing resolutions than defined for the mesh generated at operation 214 or operation 216. For a transistor, oxide/semiconductor interfaces that correspond with channel-gate interfaces may contribute to electrical behavior of a simulated transistor than oxide/semiconductor interfaces that correspond with STI-substrate interfaces. Accordingly, the region conditions may specify finer, denser meshing parameters for regions of the mesh that correspond with portions of the device structure that include channel-gate interfaces and/or depletion regions. In such example, a number, shape, and size of the elements, vertices, edges, nodes, or combinations thereof of the identified regions of the mesh are manipulated and/or changed at operation 220 to meet the defined meshing parameters (e.g., different shapes of elements and/or greater number of elements, vertices, edges, nodes, or combinations thereof in the identified regions). If no region conditions are determined at operation 218, semiconductor device simulation method 200 proceeds directly to operation 230.

Mesh generation at operation 210 also includes integrating one or more PDEs over the mesh, such as those defined at operation 205, such that each element in the mesh has a corresponding PDE (or set of PDEs) that can be assembled and/or generated using the element's corresponding structural information, boundary conditions, simulation conditions, other information and/or conditions, or combinations thereof. The PDEs (collectively referred to as device equations) describe behavior, such as electrical behavior, of the portion of the device structure to which the element corresponds and/or represents. Mesh generation at operation 210 can further include assembling the PDEs for each element into a matrix, such that each element has a corresponding matrix for modeling and/or evaluating behavior of elements of the mesh (and thus portions of the device structure).

Semiconductor device simulation method 200 then proceeds with assembling a system matrix from the mesh generated at operation 210 and solving the system matrix at operation 240 to generate behavior and/or characteristics parameters (e.g., voltages, currents, capacitances, etc.) for a semiconductor device represented by the device structure (i.e., simulate the semiconductor device and its electrical behavior). For example, semiconductor device simulation method 200 solves the system matrix (i.e., device equations of the system matrix) in an iterative fashion at operation 240 to obtain device parameters (e.g., currents, voltages, charges, etc.) that can be used to evaluate electrical behavior of the semiconductor device. The device semiconductor simulation may be a direct current (DC) simulation, an alternating current (AC) simulation, a transient simulation, a mixed mode simulation, other suitable simulation, or combinations thereof. Semiconductor device simulation method 200 can generate and output current-voltage (I-V) curves, capacitance-voltage (C-V) curves, other forms of evaluating electrical behavior, etc. based on the device parameters obtained at operation 240.

At operation 242, semiconductor device simulation method 200 can perform a pre-run solve of the system matrix. At operation 244 and operation 246, semiconductor device simulation method 200 applies a bias to the system matrix and performs coupled solving of the system matrix at the applied bias, respectively, until converging on a solution. Solving of the system matrix can be assigned to one or more solvers, such as a solver 1 to a solver N, where N is an integer and total number of solvers. Solvers 1-N can use direct numerical and/or algorithmic methods or iterative numerical and/or algorithmic methods to solve the matrixes. In the depicted embodiment, solvers 1-N use iterative numerical and/or algorithmic methods to solve the system matrix. Exemplary iterative methods include pre-conditioned conjugate gradient (PCG) method, biconjugate gradient (BCG) method, biconjugate gradient stabilized (BiCGStab) method, generalized minimal residual (GMRES) method, other suitable methods, or combinations thereof. In some embodiments, solvers 1-N solve the system matrix in parallel.

At operation 248, semiconductor device simulation method 200 evaluates whether convergence of a solution has been achieved for the system matrix. If yes, the solution generated at operation 246 has an error that is less than a defined, threshold error (i.e., an acceptable amount of error) and proceeds to operation 250 where semiconductor device simulation method 200 determines whether the device simulation is finished based on boundary conditions and/or simulation conditions, such as those that may have been received at operation 205. If no, semiconductor device simulation method 200 returns to operation 244 and repeats operations 244-248. For example, where the simulation conditions define a step size (e.g., bias steps of 0.1 V) and a bias range (e.g., 0 V to 2 V), semiconductor device simulation method 200 returns to operation 244 if system matrix has not been solved for the specified bias range. Upon returning to operation 244, semiconductor device simulation method 200 ramps (steps) up (or down) bias applied to the system matrix (e.g., by 0.1 V) and performs coupled solving of the system matrix at the ramped up/down applied bias until converging on a solution. Operations 244-250 may then be repeated until the system matrix is solved for the specified bias range.

If yes at operation 250, semiconductor device simulation method 200 proceeds to operation 255 where further operations, such as post-processing, may be performed based on the device simulation. In some embodiments, the device structure may be adjusted and/or modified based on the device simulation results (i.e., the simulated electrical behavior). For example, geometry, doping profiles, materials, etc. of the device structure may be modified to optimize electrical behavior of a device fabricated based on the device structure. In another example, process parameters for fabricating a device corresponding with the device structure may be modified to optimize electrical behavior of the device. In some embodiments, semiconductor device simulation method 200 can be performed on the modified device structure.

Returning to operation 248, if no, semiconductor device simulation method 200 determines that the solution generated at operation 246 has an error that is greater than a defined, threshold error (i.e., an unacceptable amount of error) and proceeds to operation 260 to adaptively adjust the mesh and/or the system matrix. Semiconductor device simulation method 200 adaptively adjusts the mesh and/or the system matrix using a multi-level restriction prolongation (MLRP) algorithm that balances device simulation turn-around time and accuracy. The MLRP algorithm includes at least one restriction-prolongation cycle that includes performing a restriction process on the mesh and performing a prolongation process on the restricted mesh. The restriction process is a down-sampling like process that aggregates and/or combines elements of the mesh to decrease a resolution of the mesh (i.e., the mesh is coarser and/or rougher), while the prolongation process is an up-sampling like process that increases a resolution of the mesh (i.e., the mesh is finer and/or smoother). Data of the mesh is aggregated during the restriction process and then interpolated during the prolongation process. Accordingly, the restriction process reduces device simulation time by decreasing resolution (and complexity) of the mesh and/or the system matrix (and thus improves throughput) for solving, while the prolongation process increases accuracy of the device simulation by increasing resolution (and complexity) of the mesh and/or the system matrix for solving.

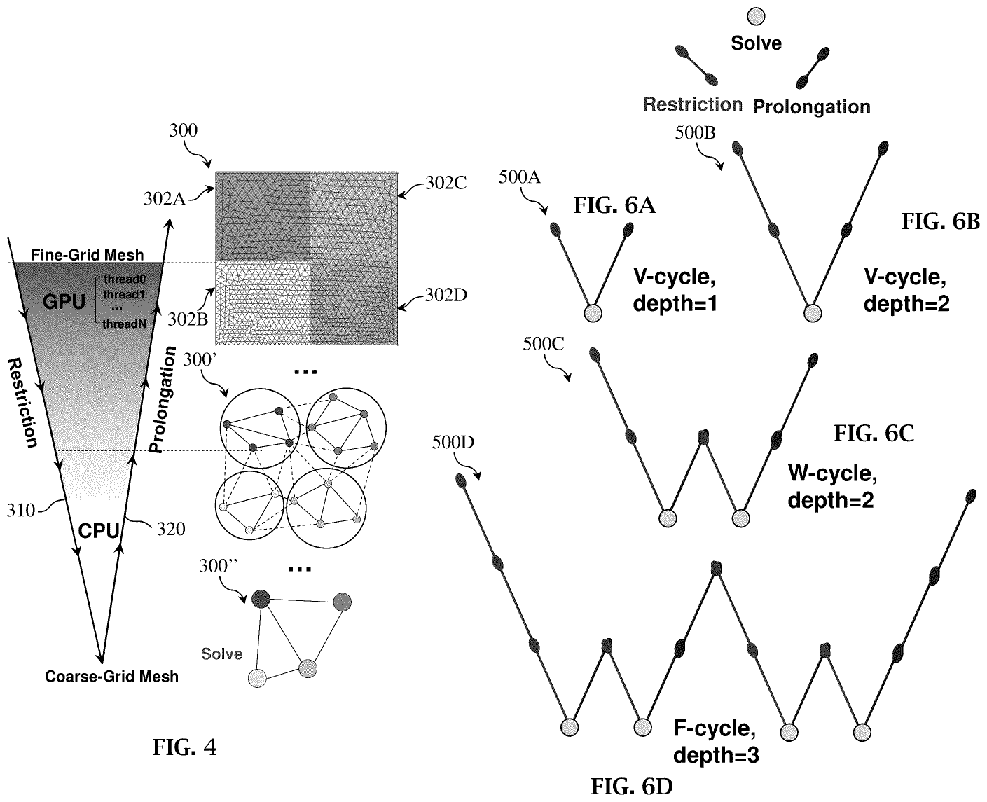

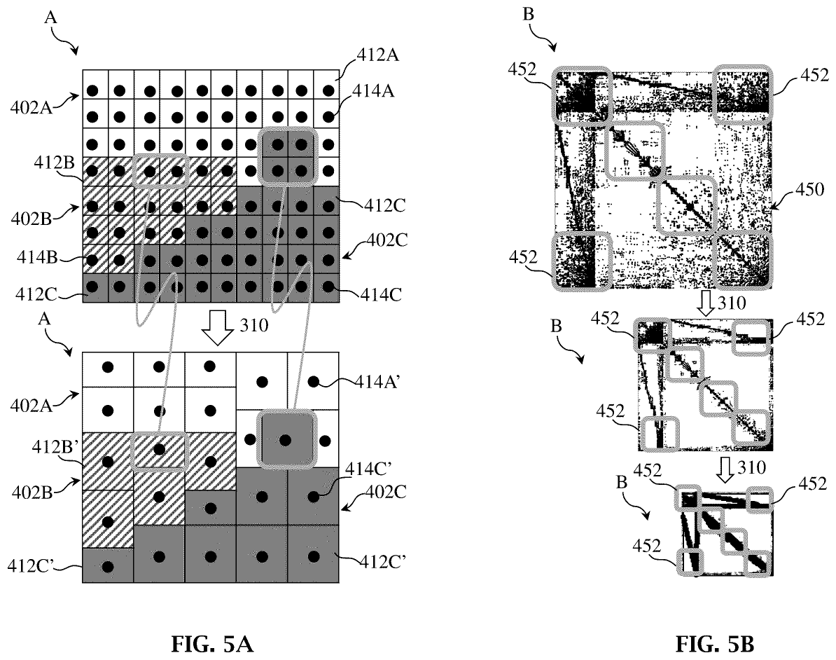

FIG. 4 illustrates execution of an MLRP algorithm, in portion or entirety, on a mesh according to various aspects of the present disclosure. FIG. 5A illustrates a mesh, in portion or entirety, that undergoes an MLRP-restriction of the MLRP algorithm according to various aspects of the present disclosure. FIG. 5B illustrates a matrix, in portion or entirety, that undergoes an MLRP-restriction of the MLRP algorithm according to various aspects of the present disclosure. FIG. 4, FIG. 5A, and FIG. 5B have been simplified for the sake of clarity to better understand the inventive concepts of the present disclosure. Additional features can be added in FIG. 4, FIG. 5A, and FIG. 5B, and some of the features described below can be replaced, modified, or eliminated in other embodiments of FIG. 4, FIG. 5A, and FIG. 5B.

In FIG. 4, MLRP is performed on an unstructured mesh 300 and/or system matrix corresponding therewith that is generated by semiconductor device simulation system 10. Unstructured mesh 300 represents a device region 302A, a device region 302B, a device region 302C, and a device region 302D of a device structure. Unstructured mesh 300 has a first resolution, such as a fine resolution, such that device regions 302A-302D are discretized into hundreds, thousands, or even millions of mesh elements, vertices, edges, nodes, etc. Unstructured mesh 300 undergoes restriction 310 to reduce a resolution thereof. For example, restriction 310 transforms unstructured mesh 300 into a restricted, unstructured mesh 300′ that has a second resolution that is less than the first resolution and then further transforms unstructured mesh 300′ into a restricted, unstructured mesh 300″ that has a third resolution that is less than the second resolution. Unstructured mesh 300 is thus manipulated from a fine-grid mesh into a coarse-grid mesh, which is represented by restricted, unstructured mesh 300″. Unstructured mesh 300′ discretizes device regions 302A-302D into tens of mesh elements, where device regions 302A-302D are represented by less than ten mesh nodes, and unstructured mesh 300″ discretizes device regions 302A-302D into four mesh nodes and two mesh elements. In some embodiments, restriction 310 transforms unstructured mesh 300 directly into restricted, unstructured mesh 300″ (i.e., a single restriction process is applied).

In FIG. 5A, a portion A of a mesh is illustrated before and after restriction 310. Portion A of the mesh includes a region 402A, a region 402B, and a region 402C. Regions 402A-402C may correspond with different material regions of a device structure, such as semiconductor, insulator, and metal regions, respectively. A size of portion A of the mesh is the same before and after restriction 310, but numbers, sizes, and shapes of elements and/or nodes of portion A are different before and after restriction 310. For example, before restriction 310, region 402A includes mesh elements 412A and mesh nodes 414A, region 402B includes mesh elements 412B and mesh nodes 414B, and region 402C includes mesh elements 412C and mesh nodes 414C. Restriction 310 combines at least two mesh elements within regions 402A-402C to reduce a number of mesh elements and/or mesh nodes within regions 402A-402C. For example, restriction 310 combines and aggregates data (i.e., structural information) from multiple mesh elements 412A-412C into mesh elements 412A′-412C′, respectively, and combines and aggregates data (i.e., structural information) from multiple mesh nodes 414A-414C into mesh nodes 414A′-414C′, respectively. As an example, two mesh elements 412B of region 402B are combined and manipulated into a single mesh element 412B′ and two mesh nodes 414B corresponding with such mesh elements 412B are combined and manipulated into a single mesh node 414B′. As another example, four mesh elements 412C of region 402C are combined and manipulated into a single mesh element 412C′ and four mesh nodes 414C corresponding with such mesh nodes 414C are combined and manipulated into a single mesh node 414C′. Reducing resolution of the mesh can reduce a size of a system matrix for solving by semiconductor device simulation system 200, which can speedup device simulation.

In FIG. 5B, a portion B of a system matrix, such as a sparse matrix, is illustrated before and after restriction 310. Portion B of the system matrix includes data points 450 that provide structural information and/or behavioral information of the device structure. A pattern of data points 450 can represent structural correlations and/or behavioral correlations of the device structure, which can be identified as signature regions 452. Restriction 310 reduces a size of portion B of the system matrix with each restriction process, which thus reduces a size and/or a resolution of the system matrix for solving by semiconductor device simulation method 200, which can speedup device simulation. Restriction 310 can be continued on portion B of the system matrix so long as signature regions 452 remain in the restricted system matrixes. Restriction of the system matrix may be achieved by applying a preconditioning algorithm to the system matrix, such as an incomplete lookup (ILU) algorithm, a diagonalization algorithm, etc. In some embodiments, portion B may correspond with unstructured mesh 300.

Returning to FIG. 4, a depth of restriction 310 (i.e., a number or restrictions and/or data aggregations) can depend on accuracy of solutions provided by a system matrix corresponding with a restricted mesh. For example, after restriction 310, semiconductor device simulation system 10 can input the restricted mesh, such as restricted, unstructured mesh 300″, into one or more solvers at operation 246 and solve a restricted system matrix corresponding therewith. If an error (or residue) of the solved, restricted system matrix is within a given error tolerance, MLRP can proceed to prolongation 320 to increase a resolution of the restricted mesh. For example, prolongation 320 transforms restricted, unstructured mesh 300″ into a prolongated, unstructured mesh that has a fourth resolution that is greater than the third resolution. Restricted, unstructured mesh 300″ is thus manipulated from a coarse-grid mesh into a fine-grid mesh that has undergone MLRP, which can be referred to hereafter as an MLRP mesh. Prolongation 320 may gradually increase a size of the MLRP mesh and/or MLRP system matrix until a resolution thereof approaches a resolution of a mesh and/or a system matrix input for MLRP processing (i.e., within a given resolution range), such as a resolution of unstructured mesh 300. For example, after prolongation, the MLRP mesh discretizes device regions 302A-302D into hundreds, thousands, or even millions of mesh elements, vertices, edges, nodes, etc. By enlarging a size of the MLRP mesh and/or the MLRP matrix, semiconductor device simulation method 200 improves accuracy of solutions to device equations of the system matrix.

Each restriction process during restriction 310 can decrease resolution of a mesh and/or a matrix by some amount, and each prolongation process during prolongation 320 can increase a resolution of a mesh and/or a matrix by some amount. Restriction processes and/or prolongation processes can be performed consecutively or alternatively. In some embodiments, a depth of restriction 310 (i.e., a number or restrictions and/or data aggregations) can depend on accuracy of solutions provided by a system matrix corresponding with a restricted mesh. For example, a first restriction process manipulates a mesh into a restricted first mesh, a second restriction process manipulates the restricted first mesh into a restricted second mesh, a third restriction process manipulates the restricted second mesh into a restricted third mesh and so on until a desired resolution and/or level of accuracy is provided by a final restricted mesh. In some embodiments, system matrix solving (i.e., operations 244-248) is performed after any restriction process and/or after any prolongation process during MLRP. In some embodiments, system matrix solving (i.e., operations 244-248) is performed at an end of a restriction-prolongation cycle and/or at an end of MLRP, when a final, MLRP mesh is input.

FIGS. 6A-6D illustrate various restriction-prolongation cycle patterns, in portion or entirety, according to various aspects of the present disclosure. FIGS. 6A-6D have been simplified for the sake of clarity to better understand the inventive concepts of the present disclosure. Additional features can be added in the restriction-prolongation cycle patterns, and some of the features described below can be replaced, modified, or eliminated in other embodiments of the restriction-prolongation cycle patterns.

In FIG. 6A, a V-cycle pattern 500A of single depth restriction-prolongation (i.e., depth=1) is performed on a mesh. For example, an MLRP process generates an MLRP mesh by restricting the mesh once, solving the system matrix using the restricted mesh, and prolongating the restricted mesh once using the solved system matrix (i.e., interpolate data for the MLRP mesh based on the solved system matrix).

In FIG. 6B, a V-cycle pattern 500B of double depth restriction-prolongation (i.e., depth=2) is performed on a mesh. For example, an MLRP process generates an MLRP mesh by restricting the mesh twice, solving the system matrix using the twice-restricted mesh, and prolongating the twice-restricted mesh twice using the solved system matrix.

In FIG. 6C, a W-cycle pattern 500C of double depth restriction-prolongation (i.e., depth=2) is performed on a mesh. For example, an MLRP process generates an MLRP mesh by restricting the mesh twice, solving the system matrix using the twice-restricted mesh (i.e., a first restricted mesh), prolongating the first restricted mesh once using the solved system matrix, restricting the mesh once (i.e., second restricted mesh), solving the system matrix using the second restricted mesh, and prolongating the second restricted mesh twice.

In FIG. 6D, an F-cycle pattern 500D of triple depth restriction-prolongation (i.e., depth=3) is performed on a mesh. For example, an MLRP process generates an MLRP mesh by restricting the mesh three times, solving the system matrix using the thrice-restricted mesh (i.e., a first restricted mesh), prolongating the first restricted mesh once using the solved system matrix (i.e., a first restricted-prolongated mesh), restricting the first restricted-prolongated mesh once (i.e., second restricted mesh), solving the system matrix using the second restricted mesh, prolongating the second restricted mesh twice (i.e., a second restricted-prolongated mesh), restricting the second restricted-prolongated mesh twice (i.e., a third restricted mesh), solving the system matrix using the third restricted mesh, prolongating the third restricted mesh using the solved system matrix (i.e., a third restricted-prolongated mesh), restricting the third restricted-prolongated mesh once (i.e., a fourth restricted mesh), solving the system matrix using the fourth restricted mesh, and prolongating the fourth restricted mesh three times.

Returning to FIG. 3, semiconductor device simulation method 200 can then use the MLRP mesh (adapted and generated at operation 260) and solve a system matrix for the MLRP mesh at operations 244-248.

Semiconductor device simulation method 200 can be implemented by semiconductor device simulation system 10. In some embodiments, CPU cluster 15 can receive the device structure (operation 205), generate the mesh (operation 210), assemble the system matrix (operation 230), and store the device structure, mesh, and system matrix in memory 25 (i.e., device simulation data). HW accelerator cluster 20 can retrieve the device simulation data for subsequent device simulation operations. In some embodiments, CPU cluster 15 and HW accelerator cluster 20 share processing associated with system matrix solving (operation 240) to improve device simulation throughput. For example, CPU cluster 15 may perform operations 242-250, while MLRP processing (operation 260 and operation 246 corresponding with operation 260 (e.g., system matrix solving for a restricted mesh)) is completely or partially parallelized on HW accelerators, such as HW accelerator cluster 20. Parallelizing MLRP processing on HW accelerator cluster 20 can dramatically shorten processing time. For example, instead of relying on CPUs having single-level high precision (e.g., double 64-bit), semiconductor device simulation 200 offloads some system matrix solving to HW accelerator cluster 20 having mixed low-high precision (e.g., 8-bit ALUs, 16-bit ALUs, 32-bit ALUs, etc.). In some embodiments, CPU cluster 15 may assign MLRP processing, restrictions thereof, prolongations thereof to parallel processing threads of a GPU (e.g., thread 0 to thread N). HW accelerator cluster 20 (e.g., one or more GPUs thereof) may generate restricted meshes, restricted-prolongated meshes, MLRP meshes, system matrixes thereof (i.e., MLRP data) and store the MLRP data in memory 25. CPU cluster 15 can retrieve the MLRP data for device simulation operations, such as performing operations 244-248 using an MLRP mesh and/or MLRP system matrix. In some embodiments, CPU cluster 15 performs MLRP processing when resolution of the MLRP mesh and/or MLRP system matrix is below a threshold resolution that CPU cluster 15 can timely and accurately handle. In some embodiments, a CPU of CPU cluster 15 or CPU cluster 15 may provide up to 64 parallel processing threads, while a GPU of HW accelerator cluster 20 or HW accelerator cluster 20 may provide thousands of parallel processing threads (e.g., 50,000 parallel processing threads). In some embodiments, CPU cluster 15 controls output of data, such as simulation data and/or MLRP data, to I/O components 30, along with internal data transfer flows of semiconductor device simulation system 10. In some embodiments, CPU cluster 15 exchanges data with memory 25 using message passing interface (MPI) and/or OpenMP parallelism.

Parallelizing MLRP processing on HW accelerator cluster 20 can substantially speed up continuum-scale, physical-based semiconductor device simulations compared to conventional, CPU-only based semiconductor device simulations. For example, it has been observed that turn-around time (TAT) for solving of Poisson equations based on an FEM mesh having up to 100 million mesh elements using MLRP algorithms of one GPU is faster than TAT of two-core and four-core CPUs, comparable to TAT of an eight-core CPU for larger mesh sizes and comparable to TAT of a sixteen-core CPU for smaller mesh sizes. Assigning the solving to two GPUs has been observed to provide a TAT that is about eight times faster than the sixteen-core CPU. Semiconductor device simulation system 10 and/or semiconductor device simulation method 200, as described herein, can thus provide a feasible TCAD solution that balances speed and accuracy, and such solution may be implemented in HPC.

The methods and/or processes described herein can be partially and/or fully embodied as code and/or data stored in a computer-readable storage medium and/or computer-readable storage device, so that when a computer system reads and executes the code and/or the data, the computer system performs the methods and/or processes described herein. The methods and/or processes described herein can be partially and/or fully embodied in hardware modules and/or hardware apparatuses, so that when the hardware modules and/or apparatuses are activated, they perform the methods and/or processes described herein. Note that the methods and/or processes can be embodied using a combination of code, data, and hardware.

Data structures and code described in the present disclosure can be partially and/or fully stored on a computer-readable storage medium, a hardware module, a hardware apparatus, or combinations thereof. A computer-readable storage medium includes, but is not limited to, volatile memory, non-volatile memory, magnetic storage devices and/or optical storage devices such as disk drives, magnetic tape, CDs (compact discs), DVDs (digital versatile discs or digital video discs), other media capable of storing code and/or data, or combinations thereof. Hardware modules and/or apparatuses described in this disclosure include, but are not limited to, ASICs, FPGAs, dedicated processors, shared processors, other hardware modules and/or processors, other hardware apparatuses, or combinations thereof.

Although not intended to be limiting, one or more embodiments of the present disclosure provide many benefits to semiconductor devices and fabrication thereof. For example, the present disclosure provides systems and methods for an EDA environment that improve accuracy and efficiency of semiconductor device simulations. Semiconductor device simulation flows described herein, which include CPU-based and HW accelerator-based parallel processing threads, speed up semiconductor device simulations and reduce time-to-market for ICs under development. Further, semiconductor device simulation flows described herein can be built-in software that comes with semiconductor manufacturing equipment and/or semiconductor device simulation equipment and/or tools or as standalone TCAD software patches.

An exemplary method for semiconductor device simulation includes receiving a device structure, generating a mesh for the device structure, simulating electrical behavior of the device structure using the mesh, and adaptively adjusting the mesh during the simulating. Adaptively adjusting the mesh includes performing a multi-level restriction-prolongation (MLRP) process that decreases and increases a resolution of the mesh. In some embodiments, the method further includes solving a system matrix for the adjusted mesh after performing the MLRP process. In some embodiments, the method further includes solving a system matrix for the adjusted mesh after performing a restriction of the MLRP process. In some embodiments, the method further includes solving a system matrix for the adjusted mesh after performing a prolongation of the MLRP process. In some embodiments, the method further includes modifying the device structure based on the simulated electrical behavior.

In some embodiments, performing the MLRP process includes performing a least one restriction-prolongation cycle. In some embodiments, the mesh has a first resolution and performing the MLRP process includes generating a restricted mesh from the mesh and generating a prolongated mesh from the restricted mesh. The restricted mesh has a second resolution that is less than the first resolution. The prolongated mesh has a third resolution that is greater than the second resolution and within a given range of the first resolution.

In some embodiments, the method further includes parallelizing the MLRP process on a hardware accelerator of a semiconductor device simulation system. In some embodiments, the method further includes performing the MLRP process on a graphics processing unit (GPU) when the resolution of the mesh is greater than or equal to a threshold resolution and performing the MLRP process on a central processing unit when the resolution of the mesh is less than the threshold resolution. In some embodiments, the method further includes performing the MLRP process on arithmetic logic units having different accuracies.

An exemplary semiconductor device simulation system includes a central processing unit (CPU) connected to a memory and a hardware accelerator connected to the CPU and the memory. The CPU, the hardware accelerator, and the memory are configured to perform a set of operations to simulate electrical behavior of a semiconductor device. The set of operations include generating a mesh for a device structure, solving a system matrix corresponding with mesh, and if a solution provided by solving the system matrix is not converged, restricting and prolongating the mesh at least once and solving a system matrix corresponding with the restricted and prolongated mesh. The restricting and the prolongating are at least partially parallelized on the hardware accelerator. In some embodiments, the restricting and the prolongating are performed partially by the CPU. In some embodiments, the hardware accelerator includes arithmetic logic units having different precisions and the restricting and prolongating are parallelized on the arithmetic logic units having different precisions.

In some embodiments, the restricting and prolongating the mesh at least once includes generating a restricted mesh by aggregating mesh elements of the mesh, solving a system matrix corresponding with the restricted mesh, and generating the restricted and prolongated mesh by interpolating mesh elements of the restricted mesh. In some embodiments, the restricted mesh is a first restricted mesh and the restricting and prolongating the mesh further includes, if an error associated with the solving the system matrix corresponding with the restricted first mesh is within an error tolerance, generating the restricted and prolongated mesh by interpolating first mesh elements of the first restricted mesh. If the error associated with the solving the system matrix corresponding with the restricted first mesh is not within the error tolerance, the method further includes generating a second restricted mesh by aggregating first mesh elements of the first restricted mesh and generating the restricted and prolongated mesh by interpolating second mesh elements of the second restricted mesh.

In some embodiments, the hardware accelerator is a cluster of graphic processing units (GPUs). In some embodiments, the CPU, the hardware accelerator, and the memory are provided by at least one CPU chip, at least one GPU chip, and at least one memory chip, respectively, of a three-dimensional, multichip package.

An exemplary non-transitory computer-readable storage medium stores instructions that, when executed by a computer, cause the computer to perform a method for simulating electrical behavior of a semiconductor device. The method includes generating a mesh for a device structure and solving a system matrix corresponding with mesh. If a solution provided by solving the system matrix is not converged, the method further includes restricting and prolongating the mesh at least once, assigning the restricting and the prolongating to parallel processing threads of a hardware accelerator of the computer, and solving a system matrix corresponding with the restricted and prolongated mesh. In some embodiments, the method further includes assigning a portion of the restricting and the prolongating to a central processing unit of the computer. In some embodiments, the method further includes performing more than one cycle of the restricting and the prolongating.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for semiconductor device simulation comprising:
receiving a device structure;
generating a mesh for the device structure;
simulating electrical behavior of the device structure using the mesh; and
adaptively adjusting the mesh during the simulating, wherein the adaptively adjusting the mesh includes performing a multi-level restriction-prolongation (MLRP) process that decreases and increases a resolution of the mesh.

2. The method of claim 1, wherein the mesh has a first resolution and the performing the MLRP process includes:
generating a restricted mesh from the mesh, wherein the restricted mesh has a second resolution that is less than the first resolution; and
generating a prolongated mesh from the restricted mesh, wherein the prolongated mesh has a third resolution that is greater than the second resolution and within a given range of the first resolution.

3. The method of claim 1, wherein the performing the MLRP process includes performing a least one restriction-prolongation cycle.

4. The method of claim 1, further comprising parallelizing the MLRP process on a hardware accelerator of a semiconductor device simulation system.

5. The method of claim 1, further comprising:
performing the MLRP process on a graphics processing unit (GPU) when the resolution of the mesh is greater than or equal to a threshold resolution; and
performing the MLRP process on a central processing unit when the resolution of the mesh is less than the threshold resolution.

6. The method of claim 1, further comprising performing the MLRP process on arithmetic logic units having different accuracies.

7. The method of claim 1, further comprising solving a system matrix for the adjusted mesh after performing the MLRP process.

8. The method of claim 1, further comprising solving a system matrix for the adjusted mesh after performing a restriction of the MLRP process.

9. The method of claim 1, further comprising solving a system matrix for the adjusted mesh after performing a prolongation of the MLRP process.

10. The method of claim 1, further comprising modifying the device structure based on the simulated electrical behavior.

11. A semiconductor device simulation system comprising:
a central processing unit (CPU) connected to a memory;
a hardware accelerator connected to the CPU and the memory; and
wherein the CPU, the hardware accelerator, and the memory are configured to perform a set of operations to simulate electrical behavior of a semiconductor device, wherein the set of operations include:
generating a mesh for a device structure,
solving a system matrix corresponding with mesh, and
if a solution provided by solving the system matrix is not converged:
restricting and prolongating the mesh at least once, wherein the restricting and the prolongating are at least partially parallelized on the hardware accelerator, and
solving a system matrix corresponding with the restricted and prolongated mesh.

12. The semiconductor device simulation system of claim 11, wherein the restricting and the prolongating are performed partially by the CPU.

13. The semiconductor device simulation system of claim 11, wherein the hardware accelerator includes arithmetic logic units having different precisions and the restricting and prolongating are parallelized on the arithmetic logic units having different precisions.

14. The semiconductor device simulation system of claim 11, wherein the restricting and prolongating the mesh at least once includes:
generating a restricted mesh by aggregating mesh elements of the mesh;
solving a system matrix corresponding with the restricted mesh; and
generating the restricted and prolongated mesh by interpolating mesh elements of the restricted mesh.

15. The semiconductor device simulation system of claim 14, wherein the restricted mesh is a first restricted mesh and the restricting and prolongating the mesh further includes:
if an error associated with the solving the system matrix corresponding with the restricted first mesh is within an error tolerance, generating the restricted and prolongated mesh by interpolating first mesh elements of the first restricted mesh; and
if the error associated with the solving the system matrix corresponding with the restricted first mesh is not within the error tolerance, generating a second restricted mesh by aggregating first mesh elements of the first restricted mesh and generating the restricted and prolongated mesh by interpolating second mesh elements of the second restricted mesh.

16. The semiconductor device simulation system of claim 11, wherein the hardware accelerator is a cluster of graphic processing units (GPUs).

17. The semiconductor device simulation system of claim 11, wherein the CPU, the hardware accelerator, and the memory are provided by at least one CPU chip, at least one GPU chip, and at least one memory chip, respectively, of a three-dimensional, multichip package.

18. A non-transitory computer-readable storage medium storing instructions and causing a computer to perform a method for simulating electrical behavior of a semiconductor device, the method comprising:
generating a mesh for a device structure;
solving a system matrix corresponding with mesh; and
if a solution provided by solving the system matrix is not converged:
restricting and prolongating the mesh at least once,
assigning the restricting and the prolongating to parallel processing threads of a hardware accelerator of the computer, and
solving a system matrix corresponding with the restricted and prolongated mesh.

19. The non-transitory computer-readable storage medium of claim 18, wherein the method further comprises assigning a portion of the restricting and the prolongating to a central processing unit of the computer.

20. The non-transitory computer-readable storage medium of claim 18, wherein the method further comprises performing more than one cycle of the restricting and the prolongating.
